(19) United States
(12) Patent Application Publication
(10) Pub. No.: US 2007/0211748 A1
(43) Pub. Date: Sep. 13, 2007

(54) Wireless network channell access techniques

(76) Inventor: Adrian P. Stephens, Cambridge (GB)

Correspondence Address: INTEL CORPORATION;c/o INTELLEVATE, LLC, P.O. BOX 52050, MINNEAPOLIS, MN, 55402, US

(21) Appl. No.: 11/375,175

(22) Filed: Mar. 13, 2006

(51) Int. Cl. H04L 12/413

(52) U.S. Cl. 370/445

(57) ABSTRACT

An embodiment of the present invention provides an an apparatus, comprising a transmitter capable of sampling a medium in a wireless network and if idle, accessing the medium, and if busy, waiting a random time within a predetermined range and re-sampling the medium. Prior to a first sampling of the medium, the transmitter may wait a first random time within a predetermined range. If the medium is busy the transmitter may continue to sample the medium after waiting subsequent random times within the predetermined range until the medium becomes idle and after the medium becomes idle, may perform a CSMA/CA attempt.

### BACKGROUND

Wireless sensors and the networks in which they operate have grown increasingly in importance. It is important for these wireless sensor networks to operate efficiently and reliably over long periods of time using the minimum amount of power.

Thus, a strong need exists for wireless sensor network channel access techniques that improve efficiency by reducing power consumption during channel access.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a method using a counter of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

In an embodiment of the present invention, modifications to the 802.11 (Carrier Sense Multiple Access with Collision Avoidance) CSMA/CA protocol may improve battery life. The present invention may substantially comply with the Institute for Electronic and Electrical Engineers (IEEE) 802.11 standard while improving battery life and providing good power-saving reductions in a busy network. The CSMA/CA protocol may be referred to as DCF (distributed channel function) in 802.11, and it may be referred to as EDCA (enhanced distributed channel access) in 802.11e. Where the term 802.11 CSMA/CA is used below, either of these closely related mechanisms may be employed. In 802.11 CSMA/CA, a channel access is performed across one or more channel access attempts by waiting for the medium to become idle (for a defined period of time), selecting a random number (in some defined range), and waiting for this number of time slots (of a defined duration). If the medium becomes busy during this time, the attempt fails and a new channel access attempt is performed, but without selecting a new random number. In this way the selected random number of time slots with the medium idle is expired before the device transmits.

Typically, activity on the wireless medium is bursty and the present invention may utilize this for improvements. Further, if the medium is busy, it is also likely to be busy in 100 us time. So in an embodiment of the present invention, power can be saved by not staying awake to continuously sample the medium if it has been sampled busy. For example, and not by way of limitation, a device that wants to transmit according to some periodic schedule may perform the following steps:
1. Wait a random time in the range 0-maxStepDelay
2. Sample the medium
3. If the medium is idle, attempt to access the medium using 802.11 CSMA/CA.
3.1 If the medium becomes busy during the 802.11 CSMA/CA channel access attempt, continue to step 4.
3.2 If the 802.11 CSMA/CA channel access attempt terminates with idle medium, transmit the packet and exit this procedure.
4. If the medium is busy, wait a random period of time in the range 0-maxStepDelay and return to step 2.

The device may save power during wait operations, for example by disabling its radio transceiver or reducing a clock frequency.

In an embodiment of the present invention, the device may also keep a timer that is started with step 1. When this timer exceeds some value, which may be referred to as maxAccessDelay, there are one of two useful behaviors:

Revert to standard 802.11 CSMA/CA. This maintains 802.11 reliability at the cost of worse battery life in a busy network.

Discard the data packet. This guarantees battery life at the cost of reliability.

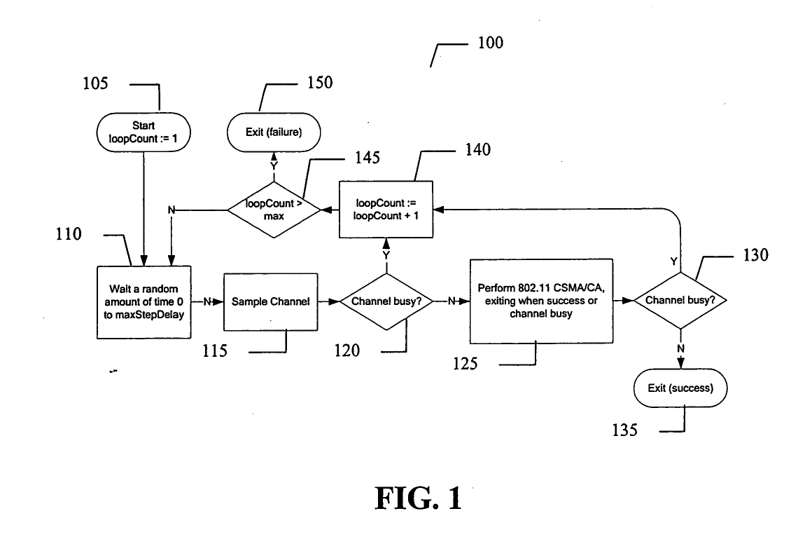

Turning now to FIG. 1 at 100 is an embodiment of the present invention, where a second timer may be replaced by a counter incremented in step 2 and tested against a “maxChannelAccessCount” limit. The method starts at 105 with a loop count=1 and at 110 waits a random amount of time between 0 and MaxStepDelay. The channel is then sampled at 115 and if it is busy, the loop count becomes loop count+1 and if the loop count reaches some maximum value, a failure to transmit occurs and exits at 150. If loop count is not at its maximum value, a return to step 110 is performed to wait again a random amount of time between 0 and MaxStepDelay. At 120 if the channel is not busy, at 125 is performed an 802.11 CSMA/CA channel access attempt. At 130 a determination is made again if the channel is busy, and if not, at 135, exit with a successful transmission. If the channel is busy, return to 140 and the loop count becomes loop count+1; and if the loop count is at its maximum value, a failure to transmit occurs and exits at 150. It is understood that although FIG. 1 is described in terms of a counter, a timer or other devices to measure time or quantitative measures may be used.

The first channel access delay may be optional, and may be only useful if there is some aspect of the application that will tend to synchronize the behavior of independent devices. In an embodiment of the present invention, maxStepDelay may be tuned to “typical burst length”. This may be set to the maximum length of a Data/Ack exchange, or obtained from 802.11e Transmit Opportunity (TXOP) limits. As an extension to 802.11, an access point (AP) could monitor the statistics of transmission duration on the air, and advise a wireless station (STA) of a good value for maxStepDelay through a new information element in the beacon, or a management action frame.

In an embodiment of the present invention, in lieu of a timer, a counter may be incremented each time the transmitter determines if the medium is idle and upon the counter reaching a predetermined value, the transmitter begins transmissions according to the Institute for Electronics and Electrical Engineers (IEEE) standard 802.11 CSMA/CA; or the apparatus discards any packets to be transmitted. In an embodiment of the present invention the predetermined range may be 0 to an average burst length of transmissions within the wireless sensor network or 0 to a maximum length of Data/Ack exchanges within the wireless sensor network. Further, the predetermined range may be obtained from 802.11e TXOP limits set forth in the IEEE 802.11e standard.

In an embodiment of the present invention, a wireless sensor network may include an access point (AP) and the AP may be capable of monitoring the statistics of transmission duration in the medium and advise apparatus of a good predetermined range.

An embodiment of the present invention further provides a machine-accessible medium that provides instructions, which when accessed, cause a machine to perform operations comprising sampling a medium in a wireless network by a transmitter and if idle, accessing said medium, and if busy, waiting a random time within a predetermined range and re-sampling said medium. The instructions causing said machine to perform operations may further comprise waiting a first random time within a predetermined range prior to a first sampling of said medium. Also, said instructions causing said machine to perform operations may further comprise continuing to sample said medium if said medium is busy after waiting subsequent random times within said predetermined range until said medium becomes idle and performing a CSMA/CA attempt after said medium becomes idle.

Another embodiment of the present invention provides a system, comprising a sensor and a transmitter associated with the sensor and operable in a wireless sensor network and wherein prior to a transmission, the transmitter waits a first random time within a predetermined range and after waiting the random time, samples a medium within a wireless sensor network, and if idle, transmits, and if busy, waits a second random time within a predetermined range and re-sampling the medium.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a transmitter capable of sampling a medium in a wireless network and if idle, accessing said medium, and if busy, waiting a period of time within a predetermined range and re-sampling said medium.

2. The apparatus of claim 1, wherein prior to a first sampling of said medium, said transmitter waits a first random time within a predetermined range.

3. The apparatus of claim 1, further comprising if said medium is busy, continuing to sample said medium after waiting subsequent random times within said predetermined range until said medium becomes idle.

4. The apparatus of claim 3, further comprising after said medium becomes idle, performing a CSMA/CA attempt.

5. The apparatus of claim 4, further comprising said transmitter transmitting after the CSMA/CA attempt completes with medium idle.

6. The apparatus of claim 4, wherein if said CSMA/CA attempt fails, waiting subsequent random times within said predetermined range until said medium becomes idle.

7. The apparatus of claim 2, further comprising a timer started when said transmitter begins waiting for said first random time and continues until said medium becomes idle and if said timer expires, said transmitter begins transmissions according to the Institute for Electronics and Electrical Engineers (IEEE) standard 802.11 Carrier Sense Multiple Access with Collision Avoidance (CSMA/CA).

8. The apparatus of claim 2, further comprising a timer started when said transmitter begins waiting for said first random time and continues until said medium becomes idle and if said time expires, said apparatus discards any packets to be transmitted.

9. The apparatus of claim 2, further comprising a counter incremented each time said transmitter determines if said medium is idle and upon said counter reaching a predetermined value, said transmitter begins transmissions according to the Institute for Electronics and Electrical Engineers (IEEE) standard 802.11 CSMA/CA.

10. The apparatus of claim 2, further comprising a counter incremented each time said transmitter determines if said medium is idle and upon said counter reaching a predetermined value, said apparatus discards any packets to be transmitted.

11. The apparatus of claim 1, wherein said predetermined range is 0 to an average burst length of transmissions within said wireless network and said period of time is a random period of time.

12. The apparatus of claim 1, wherein said predetermined range is 0 to a maximum length of Data/Ack exchanges within said wireless network.

13. The apparatus of claim 1, wherein said predetermined range is obtained from 802.11e Transmit Opportunity (TXOP) limits set forth in the IEEE 802.11e standard.

14. The apparatus of claim 1, wherein said wireless network includes an access point (AP), said AP capable of monitoring the statistics of transmission duration in said medium and advising apparatus of a good predetermined range.

15. The apparatus of claim 1, wherein said wireless network is a wireless sensor network.

16. A method, comprising:
sampling a medium in a wireless network by a transmitter and if idle, accessing said medium and if busy, waiting a random time within a predetermined range and re-sampling said medium.

17. The method of claim 16, further comprising waiting a first random time within a predetermined range prior to a first sampling of said medium.

18. The method of claim 16, further comprising continuing to sample said medium if said medium is busy after waiting subsequent random times within said predetermined range until said medium becomes idle.

19. The method of claim 18, further comprising performing a CSMA/CA attempt after said medium becomes idle.

20. The method of claim 19, further comprising said transmitter transmitting after the CSMA/CA attempt completes with medium idle.

21. The method of claim 19, further comprising waiting subsequent random times within said predetermined range if said CSMA/CA attempt fails until said medium becomes idle.

22. The method of claim 17, further comprising starting a timer when said transmitter begins waiting for said first random time and continuing until said medium becomes idle and if said timer expires, said transmitter begins transmissions according to the Institute for Electronics and Electrical Engineers (IEEE) standard 802.11 Carrier Sense Multiple Access with Collision Avoidance (CSMA/CA).

23. The method of claim 17, further comprising starting a timer when said transmitter begins waiting for said first random time and continuing until said medium becomes idle and if said time expires, discarding any packets to be transmitted.

24. The method of claim 17, further comprising incrementing a counter each time said transmitter determines if said medium is idle and upon said counter reaching a predetermined value, beginning transmissions according to the Institute for Electronics and Electrical Engineers (IEEE) standard 802.11 CSMA/CA.

25. The method of claim 17, further comprising incrementing a counter each time said transmitter determines if said medium is idle and upon said counter reaching a predetermined value, said discarding any packets to be transmitted.

26. The method of claim 16, wherein said predetermined range is 0 to an average burst length of transmissions within said wireless network.

27. The method of claim 17, wherein said predetermined range is 0 to a maximum length of Data/Ack exchanges within said wireless network.

28. The method of claim 17, wherein said predetermined range is obtained from 802.11 e Transmit Opportunity (TXOP) limits set forth in the IEEE 802.11e standard.

29. The method of claim 17, further comprising including an access point (AP) in said wireless network, said AP capable of monitoring the statistics of transmission duration in said medium and advising of a good predetermined range.

30. The method of claim 17, further comprising transmitting upon determining said medium to be idle.

31. A machine-accessible medium that provides instructions, which when accessed, cause a machine to perform operations comprising:
sampling a medium in a wireless network by a transmitter and if idle, accessing said medium, and if busy, waiting a period of time within a predetermined range and re-sampling said medium.

32. The machine-accessible medium of claim 31, further comprising said instructions causing said machine to perform operations further comprising waiting a first random time within a predetermined range prior to a first sampling of said medium.

33. The machine-accessible medium of claim 31, further comprising said instructions causing said machine to perform operations further comprising continuing to sample said medium if said medium is busy after waiting subsequent random times within said predetermined range until said medium becomes idle.

34. The machine-accessible medium of claim 33, further comprising said instructions causing said machine to perform operations further comprising performing a CSMA/CA attempt after said medium becomes idle.

35. The machine-accessible medium of claim 34, further comprising said instructions causing said machine to perform operations further comprising said transmitter transmitting after the CSMA/CA attempt completes with medium idle.

36. The machine-accessible medium of claim 34, further comprising said instructions causing said machine to perform operations further, further comprising waiting subsequent random times within said predetermined range if said CSMA/CA attempt fails until said medium becomes idle.

37. The machine-accessible medium of claim 32, further comprising said instructions causing said machine to perform operations further comprising starting a timer when said transmitter begins waiting for said first random time and continuing until said medium becomes idle and if said timer expires, said transmitter begins transmissions according to the Institute for Electronics and Electrical Engineers (IEEE) standard 802.11 Carrier Sense Multiple Access with Collision Avoidance (CSMA/CA).

38. The machine-accessible medium of claim 32, further comprising said instructions causing said machine to perform operations further comprising starting a timer when said transmitter begins waiting for said first random time and continuing until said medium becomes idle and if said time expires, discarding any packets to be transmitted.

39. The machine-accessible medium of claim 32, further comprising said instructions causing said machine to perform operations further comprising incrementing a counter each time said transmitter determines if said medium is idle and upon said counter reaching a predetermined value, said beginning transmissions according to the Institute for Electronics and Electrical Engineers (IEEE) standard 802.11 CSMA/CA.

40. The machine-accessible medium of claim 32, further comprising said instructions causing said machine to perform operations further comprising incrementing a counter each time said transmitter determines if said medium is idle and upon said counter reaching a predetermined value, said discarding any packets to be transmitted.

41. A system, comprising:
a sensor; and
a transmitter associated with said sensor and operable in a wireless sensor network and wherein prior to a transmission, said transmitter waits a first random time within a predetermined range and after waiting said random time, samples a medium within said wireless sensor network, and if idle, transmits, and if busy, waits a second random time within a predetermined range and re-sampling said medium.

42. The system of claim 41, further comprising said transmitter continuing to sample said medium after waiting subsequent random times within said predetermined range until said medium becomes idle.

43. The system of claim 42, further comprising a timer started when said transmitter begins waiting for said first random time and continues until said medium becomes idle and if said timer expires, said transmitter begins transmissions according to the Institute for Electronics and Electrical Engineers (IEEE) standard 802.11 CSMA/CA.

44. The system of claim 42, further comprising a timer started when said transmitter begins waiting for said first random time and continues until said medium becomes idle and if said time expires, said apparatus discards any packets to be transmitted.

45. The system of claim 42, further comprising a counter incremented each time said transmitter determines if said medium is idle and upon said counter reaching a predetermined value, said transmitter begins transmissions according to the Institute for Electronics and Electrical Engineers (IEEE) standard 802.11 CSMA/CA.

46. The system of claim 42, further comprising a counter incremented each time said transmitter determines if said medium is idle and upon said counter reaching a predetermined value, said apparatus discards any packets to be transmitted.
